(19) United States
(12) Patent Application Publication
(10) Pub. No.: US 2020/0284367 A1
(43) Pub. Date: Sep. 10, 2020

(54) JOINT BLOCK AND FLUID CONTROL SYSTEM USING SAME

(71) Applicant: FUJIKIN INCORPORATED, Osaka (JP)

(72) Inventors: Shotaro KUDO, Osaka (JP); Hidehiro DOYA, Osaka (JP)

(73) Assignee: FUJIKIN INCORPORATED, Osaka (JP)

(21) Appl. No.: 16/497,665

(22) PCT Filed: Mar. 13, 2018
(86) PCT No.: PCT/JP2018/009650

§ 371 Date: Sep. 25, 2019

(30) Foreign Application Priority Data
Mar. 28, 2017 (JP) 2017-062857

(51) Int. Cl. F16K 27/00

(52) U.S. Cl. CPC F16K 27/003

(57) ABSTRACT

To provide a joint block suitable for a fluid control system which, without reducing the supply flow rate of a fluid, is considerably more compact and integrated. The problem is solved by a joint block including a main flow path that includes upstream side and downstream side openings, sub flow paths that includes first and second openings disposed between the upstream side and downstream side openings in a longitudinal direction, and a connecting flow path that is connected to the main flow path at one end part, and includes an opening that opens at an upper surface and opens between the second opening of the sub flow path and the downstream side opening in the longitudinal direction at the other end part. The main flow path is disposed so as to partially overlap with the sub flow paths and the connecting flow path in a top view.

### FIELD OF THE INVENTION

The present invention relates to a joint block and a fluid control system that uses the joint block.

### DESCRIPTION OF THE BACKGROUND ART

As a fluid control system used to supply various gases to a processing chamber of a semiconductor manufacturing system or the like, there have been known, for example, the system disclosed in Patent Document 1.

In the fluid control system disclosed in Patent Document 1, a plurality of process gas assemblies 50, 52, 54, 56, 58 extending from an upstream side toward a downstream side are arranged in parallel on a common plate, and a purge gas assembly 60 is disposed adjacent to the process gas assembly 58. The purge gas assembly 60 plays a role of supplying a purge gas to a gas flow path of the process gas assemblies as necessary.

### PATENT DOCUMENTS

Patent Document 1: JP2001-521120A

### SUMMARY OF THE INVENTION

### Problems to be Solved by the Invention

In a fluid control system such as described above, an interlock, that is, a safety system, is always provided. In Patent Document 1, manual valves 130, 176 are provided on the upstream side of the plurality of process gas assemblies and on the upstream side of the purge gas assembly, respectively, and automatic valves 134, 280 are provided adjacent to the downstream sides of the manual valves 130, 176, respectively.

However, in the field of a fluid control system such as described above, higher responsiveness is required to control the supply of the various gases. To this end, the fluid control system needs to be made more compact and integrated to the extent possible to install the system closer to the processing chamber serving as the gas supply destination.

Further, along with increase in the size of the materials to be processed, such as the increase in size of the diameter of the semiconductor wafer, it becomes necessary to also increase a supply flow rate of the fluid supplied from the fluid control system into the processing chamber accordingly.

When the fluid control system is simply made more compact, the cross-sectional area of the fluid flow path also decreases, and the supply flow rate is also reduced.

An object of the present invention is to provide a joint block suitable for making the fluid control system more compact.

Another object of the present invention is to provide a fluid control system that uses the joint block described above and, without reducing the supply flow rate of a fluid, is considerably more compact and integrated.

Yet another object of the present invention is to provide a semiconductor manufacturing method and a semiconductor manufacturing system that use the fluid control system described above.

### Means for Solving the Problems

A joint block according to the present invention is a joint block defining an upper surface and a bottom surface opposing each other, and side surfaces extending from the upper surface toward the bottom surface side, and comprises:

a main flow path that includes a flow path extending inside the joint block from one end side toward the other end side in a longitudinal direction, and one end side opening and the other end side opening that open on one end side and the other end side at the upper surface,

a sub flow path that includes a flow path extending inside the joint block from one end side toward the other end side in the longitudinal direction, and a first opening that opens on one end side and a second opening that opens on a downstream side at the upper surface, the first opening and the second opening being formed between the one end side opening and the other end side opening in the longitudinal direction, and

a connecting flow path that is connected to the main flow path at one end part, and includes a third opening that opens at the upper surface and opens between the second opening of the sub flow path and the other end side opening of the main flow path in the longitudinal direction at the other end part.

The main flow path is formed so as to partially overlap with the sub flow path and the connecting flow path in a top view, and is formed independently from the sub flow path.

A fluid control system according to the present invention comprises:

a plurality of fluid devices arranged in one direction,

the joint block described in claim 1, and

a pipeline member connected with the first opening of the sub flow path.

At least one of the plurality of fluid devices is disposed on the second opening and the third opening of the upper surface of the joint block, and includes a body that defines a flow path interconnecting the second opening and the third opening.

A semiconductor manufacturing method according to the present invention is a semiconductor manufacturing method that uses the fluid control system described above, and comprises the steps of:

connecting a most-downstream side end part interconnected to the main flow path to a processing chamber,

interconnecting all of the sub flow paths with the main flow path via the connecting flow path, and supplying a purge gas to such a reactor through the first openings of the sub flow paths, and

blocking the interconnection of the sub flow paths with the main flow path via the connecting flow path, and supplying a gas other than the purge gas to the reactor through the main flow path.

A semiconductor manufacturing system of the present invention is a semiconductor manufacturing system including the fluid control system described above.

A most-downstream side end part interconnected to the main flow path is connected to a processing chamber, all of the sub flow paths are interconnected with the main flow path via the connecting flow path, and a purge gas is supplied to the processing chamber through the first openings of the sub flow paths, the interconnection of the sub flow paths with the main flow path via the connecting flow path is blocked, and a gas other than the purge gas is supplied to the processing chamber through the main flow path.

### Effect of the Invention

According to the present invention, in a fluid control assembly including a plurality of fluid devices arranged in one direction and connected to each other by a main flow path that allows a process gas or the like to flow therethrough, it is possible to integrate a sub flow path that allows a purge gas or the like to flow therethrough and fluid devices, such as a valve device that opens and closes the sub flow path, and to make the fluid control system more compact.

### BRIEF DESCRIPTION OF THE DRAWINGS

FIG. 1A is a perspective view of a fluid control system according to an embodiment of the present invention.

FIG. 1B is a top view of the fluid control system in FIG. 1A.

FIG. 1C is a front view partially including a cross section along line 1C-1C in FIG. 1B.

FIG. 2A is a joint block according to an embodiment of the present invention.

FIG. 2B is a top view of the joint block in FIG. 2A.

FIG. 2C is a sectional view along line 2C-2C of the joint block in FIG. 2B.

FIG. 3A is a front view including a partial cross section of a fluid control system according to another embodiment of the present invention.

FIG. 3B is a sectional view of the joint block used in the fluid control system in FIG. 3A.

FIG. 4 is a front view including a partial cross section of a fluid control system according to yet another embodiment of the present invention.

FIG. 5 is a schematic drawing illustrating a configuration example of a semiconductor manufacturing system to which a fluid control system 1 is applied.

### DESCRIPTION OF THE PREFERRED EMBODIMENTS

Embodiments of the present invention are described below with reference to the drawings. It should be noted that, in this specification and the drawings, components having substantially the same function are denoted using the same reference numeral, and duplicate descriptions thereof are omitted.

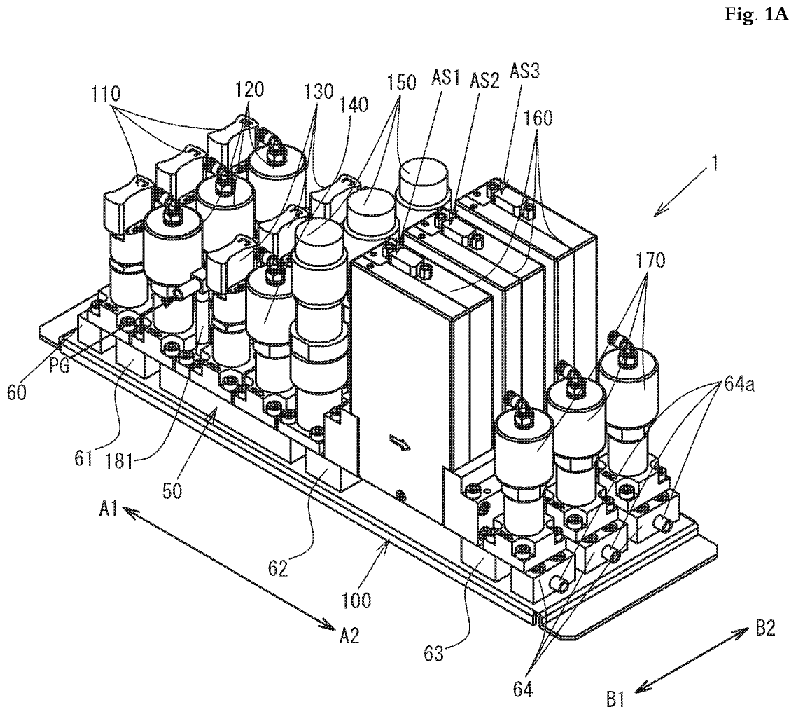

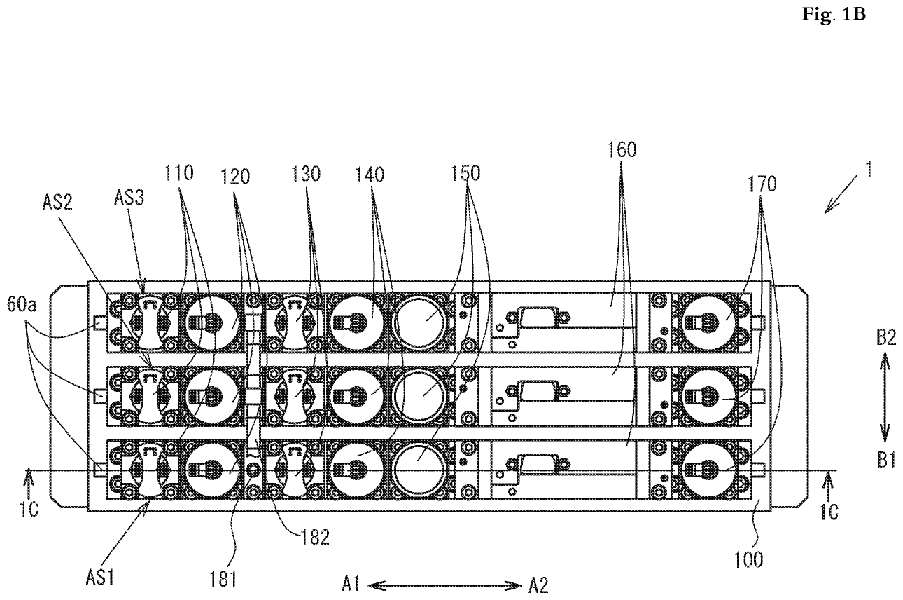

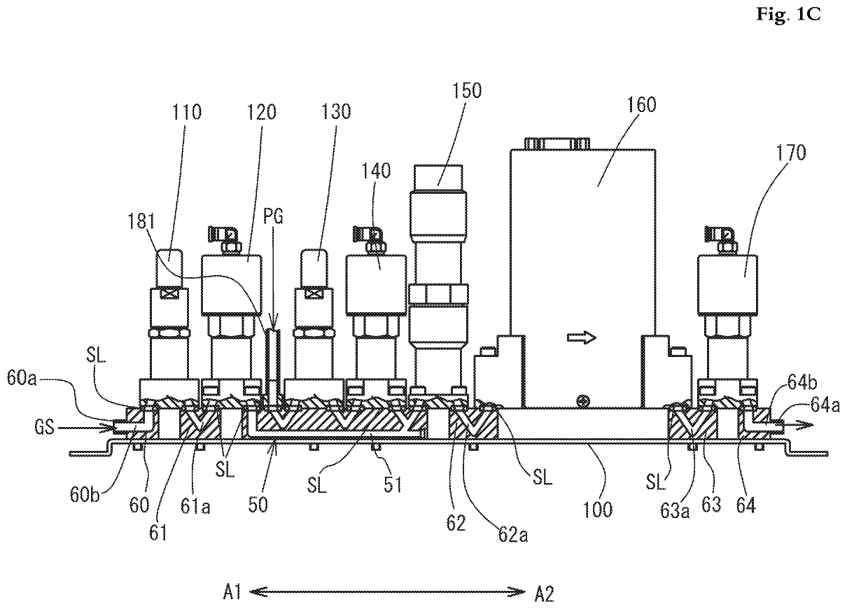

FIGS. 1A to 1C are drawings illustrating a structure of a fluid control system 1 according to an embodiment of the present invention. It should be noted that arrows A1, A2 in FIGS. 1A to 1C indicate directions in which fluid devices are arranged, and here are longitudinal directions, A1 being an upstream side and A2 being a downstream side. Arrows B1, B2 indicate width directions orthogonal to the longitudinal directions.

The fluid control system 1 is used to supply various gases to a processing chamber of a semiconductor manufacturing system or the like.

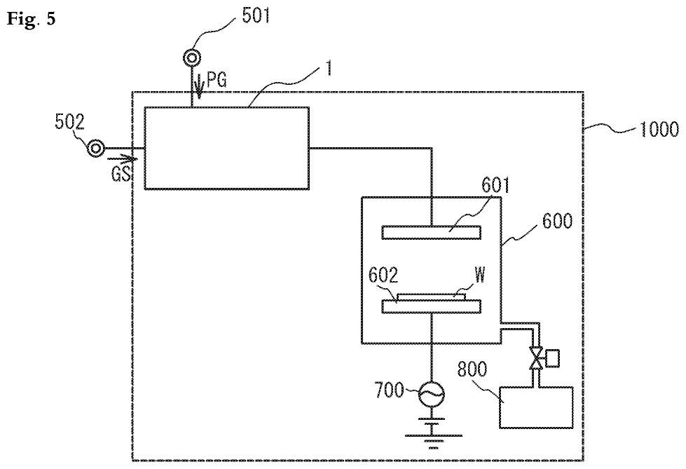

Here, before a description is made of the fluid control system 1, a configuration example of the semiconductor manufacturing system to which the fluid control system 1 is applied is illustrated in FIG. 5.

A semiconductor manufacturing system 1000 includes the fluid control system 1, a processing chamber 600, and a vacuum pump 800.

Various gases G are supplied from a gas supply source 502 and a purge gas PG is supplied from a purge gas supply source 501 to the fluid control system 1.

A gas that passes through the fluid control system 1 is supplied to a shower plate 601 in the processing chamber 600. A wafer W is disposed on a stage 602 provided below the shower plate 601. The wafer W is processed by the gas from the shower plate 601. A voltage is applied between the shower plate 601 and the stage 602 by a power source. During the processing of the wafer W, the pressure inside the processing chamber 600 is reduced by the vacuum pump 800.

As understood from FIGS. 1A to 1C, a plurality of (three) fluid control assemblies AS1, AS2, AS3 extending in the longitudinal directions A1, A2 are arranged in the width directions B1, B2 on a base sheet metal 100.

The fluid control assemblies AS1, AS2, AS3 have a common structure and include joint blocks 60, 50, 61, 62, 63, 64 arranged in a row in the longitudinal directions A1, A2 on the base metal plate 100, and a manual valve 110, an automatic valve 120, a manual valve 130, an automatic valve 140, an automatic valve 150, a mass flow controller (MFC) 160, and an automatic valve 170 as fluid devices fixed on the plurality of joint blocks.

In the joint block 60, a pipe part 60a for introducing a gas GS other than the purge gas PG is formed protruding from a side surface, and a flow path 60b formed in a block interior and interconnected with the pipe part 60a opens at an upper surface and is connected with a bottom surface side opening of a flow path formed in a body of the manual valve 110.

A seal member SL having a ring shape and formed by a metal or a resin is provided to a periphery of an opening of the joint block 60 and an opening of the manual valve 110, and pressed by a tightening force of a bolt that tightens the joint block 60 and the body of the manual valve 110, sealing the area between the openings. This seal structure is the same between the other joint blocks and the bodies of fluid devices.

The joint block 61 fluidly connects the manual valve 110 and the automatic valve 120 via a flow path 61a.

The joint block 62 fluidly connects the automatic valve 150 and the MFC 160 via a flow path 62a.

The joint block 63 fluidly connects the MFC 160 and the automatic valve 170 via a flow path 63a.

The joint block 64 has a structure common to the joint block 60, and outputs the gas GS or the purge gas PG from a pipe part 64a through a flow path 64b fluidly connected with the automatic valve 170. The pipe part 64a is connected to the processing chamber 600 of the semiconductor manufacturing system 1000 via piping.

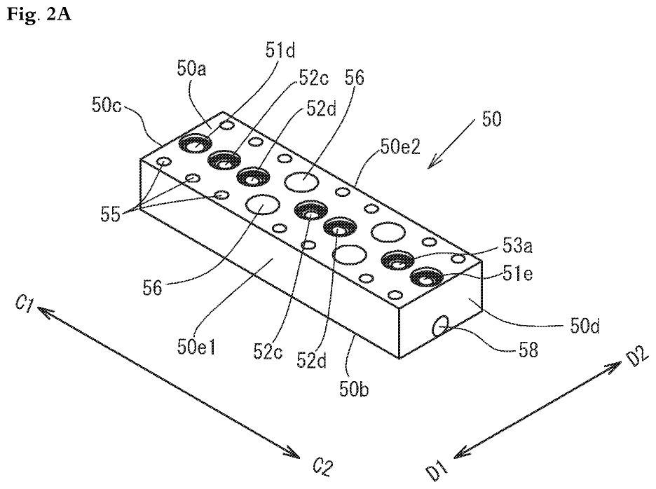

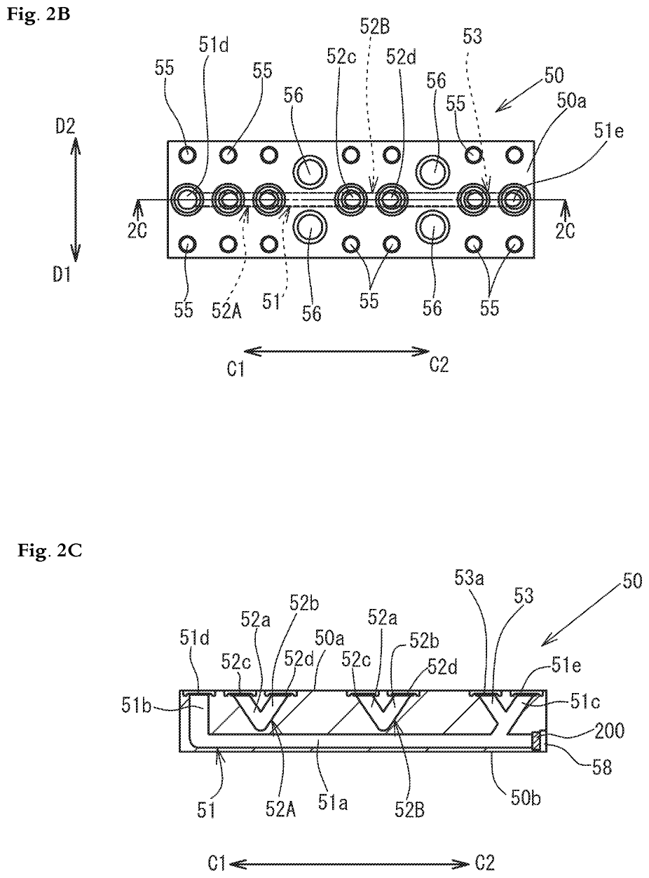

FIGS. 2A to 2C are drawings illustrating the structure of the joint block 50. In FIGS. 2A to 2C, the arrows C1, C2 indicate longitudinal directions, C1 being a longitudinal direction upstream side and C2 being a longitudinal direction downstream side. Arrows D1, D2 indicate width directions orthogonal to the longitudinal directions C1, C2.

The joint block 50 is a block made of a metal and formed in a rectangular parallelepiped shape, and defines an upper surface 50a and a bottom surface 50b opposing each other, end surfaces 50c, 50d on the upstream side and the downstream side extending from the upper surface 50a toward the bottom surface 50b side, and two side surfaces 50e1, 50e2 extending from the upper surface 50a toward the bottom surface 50b side along the longitudinal directions C1, C2. Reference numeral 55 denotes a screw hole for screwing a bolt for tightening the body of a fluid device or a piping joint to the upper surface, and reference numeral 56 denotes a through hole for inserting a bolt for attaching the joint block 50 to the base sheet metal 100.

A main flow path 51 includes a flow path (long path part) 51a extending inside the joint block 50 from the upstream side toward the downstream side in the longitudinal directions C1, C2, a flow path 51b extending vertically relative to the upper surface 50a and connected with the flow path 51a on the upstream side, and a flow path 51c extending so as to obliquely incline relative to the upper surface 50a and connected with the flow path 51a on the downstream side. A downstream side end part of the flow path 51a is interconnected with an opening 58, a closing member 200 is provided to the downstream side end part of the flow path 51a through the opening 58 and fixed by a fixing means such as welding, to thereby close the downstream side end part of the flow path 51a.

The main flow path 51 includes an upstream side opening 51d as one end side opening where the flow path 51b opens at the upper surface 50a, and a downstream side opening 51e as the other end side opening where the flow path 51c opens at the upper surface 50a. A protrusion having an annular shape for pressing the seal member SL described above, and a holding part that holds the seal member SL are provided on outer peripheral parts of the upstream side opening 51d and the downstream side opening 51e, but descriptions thereof are omitted. Further, the openings at the upper surface of all joint blocks of the present embodiment have the same configuration.

In the present embodiment, the flow path extending from the downstream side opening 51e as the other end side opening to the flow path (long path part) 51a extends obliquely from the upper surface 50a in the longitudinal direction. Nevertheless, the flow path 51b extending vertically from the upstream side opening 51d serving as one end side opening to the long path part 51a may also extend obliquely from the upper surface 50a in the longitudinal direction, or only the flow path 51b extending from the upstream side opening 51d may extend obliquely in the longitudinal direction.

A sub flow path 52A includes flow paths 52a, 52b extending inside the joint block 50 from the upstream side toward the downstream side in the longitudinal directions C1, C2, inclined reversely to each other, and internally connected, and a first opening 52c and a second opening 52d that open on the upstream side and the downstream side at the upper surface 50a. The first and second openings are formed between the upstream side opening 51d and the downstream side opening 51e in the longitudinal directions C1, C2.

A sub flow path 52B is formed on the downstream side of the sub flow path 52A and, similar to the sub flow path 52A, includes the flow paths 52a, 52b as well as the first opening 52c and the second opening 52d that open on the upstream side and the downstream side at the upper surface 50a.

A connecting flow path 53 is formed so as to incline relative to the upper surface 50a, and one end part inside the joint block 50 is connected to the middle of the flow path 51c of the main flow path 51. The other end part of the connecting flow path 53 includes an opening 53a serving as a third opening that opens at the upper surface 50a. The opening 53a is positioned between the second opening 52d of the sub flow path 52B and the downstream side opening 51e of the main flow path 51 in the longitudinal directions C1, C2. In the present embodiment, the connecting flow path 53 extends obliquely from the upper surface 50a to the other end side in the longitudinal direction. The connecting flow path 53, however, may open orthogonal to the upper surface 50a and be connected with the main flow path 51.

Here, the positional relationship between the main flow path 51, the sub flow paths 52A, 52B, and the connecting flow path 53 described above will be described.

As illustrated in FIG. 2B, the main flow path 51, the sub flow paths 52A, 52B, and the connecting flow path 53 are disposed overlapping in a top view. Additionally, the main flow path 51, as illustrated in FIG. 2C, is formed so as to detour in the bottom surface 50b side to circumvent the sub flow paths 52A, 52B. As a result, the main flow path 51 is disposed in a path different from the sub flow path 52A or 52B inside the joint block 50, forming an independent flow path not mutually connected. While a plurality of the sub flow paths 52A or 52B are disposed in the longitudinal direction, the number of sub flow paths may be one or may be three or more.

It should be noted that, while the main flow path 51, the sub flow paths 52A, 52B, and the connecting flow path 53 are disposed overlapping in a top view in the present embodiment, the present invention is not necessarily limited thereto and these flow paths may be disposed partially overlapping. Further, while the openings of the main flow path 51, the sub flow paths 52A, 52B, and the connecting flow path 53 are disposed on a straight line in the present embodiment, the present invention is not necessarily limited thereto and a configuration in which the positions of the openings deviate in the width directions D1, D2 can also be adopted.

The main flow path 51, as illustrated in FIG. 1C, is fluidly connected with the flow path formed in the body of the automatic valve 120, allowing the pressure-regulated gas GS other than the purge gas PG to flow therethrough.

The first opening 52c of the sub flow path 52A, as illustrated in FIG. 1C, is fluidly connected with a gas supply pipe 181 for purge gas supply. The gas supply pipe 181 is fluidly connected to the first opening 52c of the sub flow path 52A of the joint block 50 of the plurality of fluid control assemblies AS1 to AS3, these gas supply pipes 181 are fluidly connected to each other by a gas supply pipe 182 as illustrated in FIG. 1B and the like, and the gas supply pipe 182 is fluidly connected to a gas supply pipe 180 introduced from outside the device, as illustrated in FIG. 1A. The purge gas PG is supplied from the outside through the gas supply pipe 180.

The second opening 52d of the sub flow path 52A and the first opening 52c of the sub flow path 52B are fluidly connected with two openings that open toward the bottom surface of the body of the manual valve 130, and the sub flow path 52A and the sub flow path 52B are fluidly connected via the flow path of the manual valve 130.

The second opening 52d of the sub flow path 52B and the opening 53a of the connecting flow path 53 are fluidly connected with two openings that open toward the bottom surface of the body of the automatic valve 140, and the sub flow path 52B and the main flow path 51 are fluidly connected via the flow path of the automatic valve 140 and the connecting flow path 53.

In the fluid control system 1 of the above-described configuration, when the gas GS other than the purge gas PG is supplied to the processing chamber 600 and predetermined conditions are all satisfied, the manual valve 110 is released, the automatic valve 120 is also released, and the manual valve 130 and the automatic valve 140 are closed. As a result, the main flow path 51 of the joint block 50 is fluidly connected to the processing chamber 600 through the pipe part 64a of the joint block 64, which is the most-downstream side end part interconnected thereto. Then, the gas GS supplied through the pipe part 60a of the joint block 60 flows through the main flow path 51 and is ultimately supplied to the processing chamber 600.

In the fluid control system 1 of the above-described configuration, when the purge gas PG is supplied to the processing chamber 600 and predetermined conditions are all satisfied, the manual valve 110 is closed, the automatic valve 120 is also closed, and the manual valve 130 and the automatic valve 140 are released. As a result, all of the sub flow paths 52A, 52B of the joint block 50 are fluidly connected to the main flow path 51 via the connecting flow path 53, and the purge gas PG supplied from the gas supply pipe 180 flows through the sub flow paths 52A, 52B, the connecting flow path 53, and the main flow path 51, and is ultimately supplied to the processing chamber 600.

According to the present embodiment, the joint block 50 is used to integrate the purge gas supply path with a supply path of a gas other than the purge gas PG, such as a process gas or a cleaning gas, eliminating the need for an independent purge gas assembly for the purge gas PG and making it possible to decrease the dimensions of the device, particularly the dimensions in the width directions B1, B2.

It should be noted that, while the joint block 50 described in the present embodiment exemplifies a case where the supply system of the purge gas PG and the supply system of the gas GS other than the purge gas are integrated, the joint block is applicable to combinations other than such a combination of gases as well.

While the upper surface 50a of the joint block 50 is a flat surface in the above-described embodiment, the present invention is not necessarily limited thereto and may be a curved surface or a surface with bumps or unevenness.

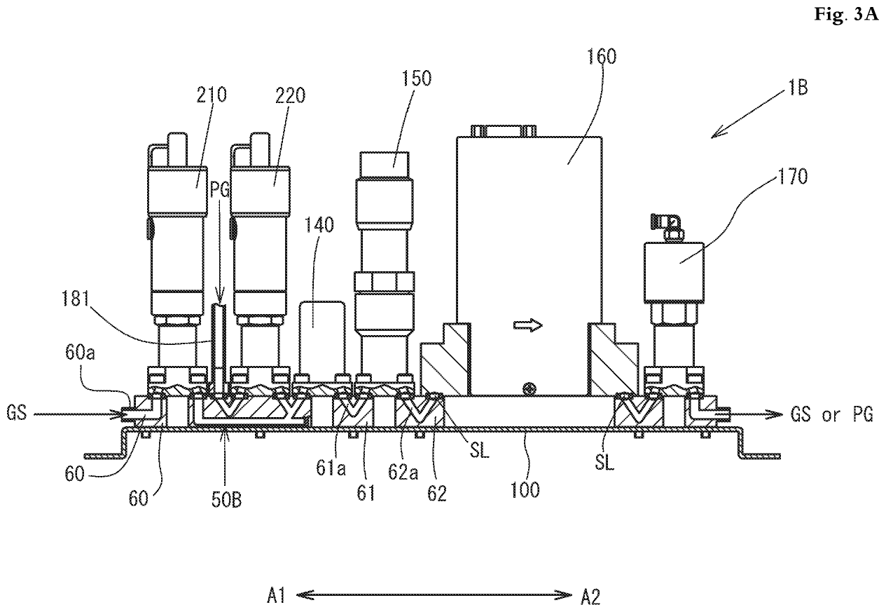

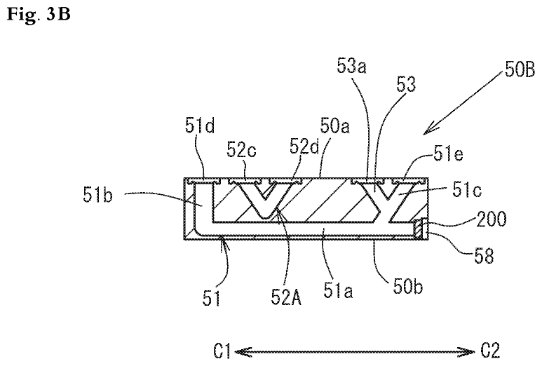

FIGS. 3A and 3B are drawings illustrating another embodiment of the present invention. It should be noted that the fluid control system 1 according to the above-described embodiment and a fluid control system 1B illustrated in FIG. 3A differ in that hybrid valves 210, 220 are used in place of the manual valves 110, 130 and the automatic valve 120, and a joint block 50B is used in place of the joint block 50.

The hybrid valves 210, 220 are valves capable of automatic and manual operation.

The joint block 50B includes only the sub flow path 52A and not the sub flow path 52B. All other components are the same as those of the joint block 50 described above.

By adopting such a joint block 50B, it is possible to make the device even more compact.

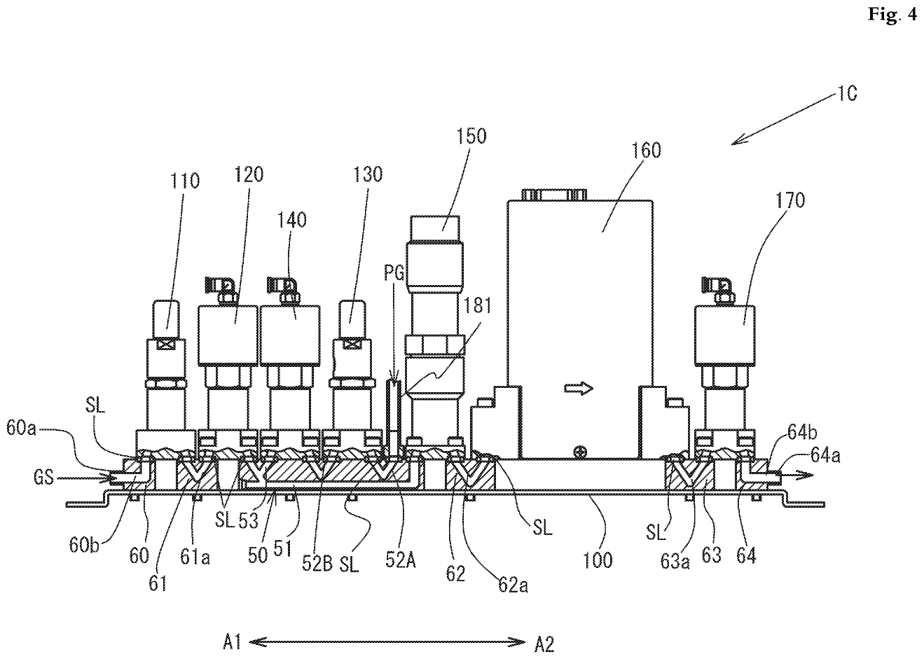

FIG. 4 is a drawing illustrating yet another embodiment of the present invention.

In the joint block 50 of a fluid control system 1C illustrated in FIG. 4, the other end side, where the connecting flow path 53 is disposed, is disposed on the upstream side, and the other end side is disposed on the downstream side.

According to this configuration, when the manual valve 110 and the automatic valve 120 are closed and the manual valve 130 and the automatic valve 140 are opened to supply the purge gas PG, it is possible to allow the purge gas to flow through the main flow path 51 through the sub flow paths 52A, 53B and the connecting flow path 53, and reliably implement purge treatment inside the main flow path 51.

### DESCRIPTIONS OF REFERENCE NUMERALS

1, 1B, 1C Fluid control system
50, 50B Joint block
51 Main flow path
52A, 52B Sub flow path
53 Connecting flow path
60, 61, 62, 63, 64 Joint block
110 Automatic valve (Fluid device)
120 Automatic valve (Fluid device)
130 Manual valve (Fluid device)
140 Filter (Fluid device)
150 Automatic valve (Fluid device)
160 Mass flow controller (Fluid device)
170 Automatic valve (Fluid device)
180, 181, 182 Gas supply pipe
210, 220 Hybrid valve
AS1 to AS3 Fluid control assembly
GS Gas
PG Purge gas
A1, A2 Longitudinal direction (One direction)
B1, B2 Width direction
C1, C2 Longitudinal direction

1. A joint block defining an upper surface and a bottom surface opposing each other, and side surfaces extending from the upper surface toward the bottom surface side, the joint block comprising:
a main flow path that includes a flow path extending inside the joint block from one end side toward the other end side in a longitudinal direction, and one end side opening and the other end side opening that open on one end side and the other end side at the upper surface;
a sub flow path that includes a flow path extending inside the joint block from one end side toward the other end side in the longitudinal direction, and a first opening that opens on one end side and a second opening that opens on a downstream side at the upper surface, the first opening and the second opening being formed between the one end side opening and the other end side opening in the longitudinal direction; and
a connecting flow path that is connected to the main flow path at one end part, and includes a third opening that opens at the upper surface and opens between the second opening of the sub flow path and the other end side opening of the main flow path in the longitudinal direction at the other end part, wherein
the main flow path is formed so as to partially overlap with the sub flow path and the connecting flow path in a top view.

2. The joint block according to claim 1, wherein
a plurality of the sub flow paths are formed in the longitudinal direction.

3. The joint block according to claim 1, wherein
the main flow path includes a long path part extending in the longitudinal direction, and
at least one flow path extending from the one end side opening or the other end side opening to the long path part extends obliquely from the upper surface in the longitudinal direction.

4. The joint block according to claim 1, wherein
the connecting flow path extends obliquely from the upper surface to the other end side in the longitudinal direction.

5. A fluid control system comprising:
a plurality of fluid devices arranged in one direction;
the joint block described in claim 1; and
a pipeline member connected with the first opening of the sub flow path, wherein
at least one of the plurality of fluid devices is disposed on the second opening and the third opening of the upper surface of the joint block, and includes a body defining a flow path interconnecting the second opening and the third opening.

6. The fluid control system according to claim 5, wherein
at least one of the plurality of fluid devices is a valve device.

7. The fluid control system according to claim 5, wherein
a first gas is supplied through the pipeline member, and
a second gas other than the first gas is supplied to the main flow path.

8. A semiconductor manufacturing method using the fluid control system described in claim 5, the method comprising:
connecting a most-downstream side end part interconnected to the main flow path to a processing chamber;
interconnecting all of the sub flow paths with the main flow path via the connecting flow path, and supplying a purge gas to the processing chamber through the first openings of the sub flow paths; and
blocking the interconnection of the sub flow paths with the main flow path via the connecting flow path, and supplying a gas other than the purge gas to the processing chamber through the main flow path.

9. A semiconductor manufacturing system comprising the fluid control system described in claim 5, wherein
a most-downstream side end part interconnected to the main flow path is connected to a processing chamber,
all of the sub flow paths are interconnected with the main flow path via the connecting flow path, and
a purge gas is supplied to the processing chamber through the first openings of the sub flow paths, the interconnection of the sub flow paths with the main flow path via the connecting flow path is blocked, and a gas other than the purge gas is supplied to the processing chamber through the main flow path.
